(19) United States
(12) Patent Application Publication
(10) Pub. No.: US 2014/0138961 A1
(43) Pub. Date: May 22, 2014

(54) HOOD LATCH STRUCTURE

(71) Applicant: HYUNDAI MOTOR COMPANY, Seoul (KR)

(72) Inventor: In Hwang, Hwaseong-si (KR)

(73) Assignee: Hyundai Motor Company, Seoul (KR)

(21) Appl. No.: 13/771,679

(22) Filed: Feb. 20, 2013

(30) Foreign Application Priority Data
Nov. 22, 2012 (KR) 10-2012-0132943

(51) Int. Cl. E05B 65/12

(52) U.S. Cl. CPC E05B 83/18
USPC 292/122; 292/96

(57) ABSTRACT

A hood latch structure may include a base plate mounted in a vehicle, a pole rotatably provided at the base plate, a hood release cable having one end connected to the pole to rotate the pole, and a latch having a first end rotatably mounted at the base plate and a latching groove formed at a center thereof to allow a hood striker to be selectively inserted thereinto, wherein the latching groove may be selectively engaged with the pole.

### CROSS-REFERENCE TO RELATED APPLICATION

The present application claims priority to Korean Patent Application No. 10-2012-0132943, filed on Nov. 22, 2012, the entire contents of which is incorporated herein for all purposes by this reference.

### BACKGROUND OF THE INVENTION

1. Field of the Invention

The present invention relates to a hood latch structure, and more particularly, to a hood latch structure capable of having a minimized size.

2. Description of Related Art

Generally, a vehicle is installed with a hood blocking engine noise while protecting an engine room. A wire pulls a latch according to a manipulation of a button or a lever (not shown) installed in the hood vehicle, such that primary latching is unlatched, and a hand is put in the engine room to press a button of a safety hook, thereby opening the hood, in order to unlatch secondary unlatching.

In the hood latch according to the related art, as shown in FIG. 1, a hood 110 is doubly latched by a latch 114 and a safety hook 121.

A front end portion of the hood 110 is installed with a striker 111, a vehicle body corresponding to a position at which the striker 111 is installed is installed with a support base 112, and an upper portion of the support base 112 is provided with a guide groove 113 so that the striker 111 may enter the support base 112.

The latch 114 is installed on the support base 112 so as to be rotatable via a latch spring 117, a hook 115 of which a front end is downwardly inclined is formed at a front side of the latch 114, and a support jaw 116 is formed at a lower portion of the front side of the latch so that a predetermined groove is provided between the support jaw 116 and the hook 115. In addition, the striker 111 is positioned in the groove provided between the hook 115 and the support jaw 116 and is latched by the hook 115.

A pole 118 is installed on a front surface of the support base 112 so as to be rotatable via a pole spring 120. The pole 118 contacts a front end portion of the support jaw 116 of the latch 114 to prevent the latch 114 from being rotated by restoring force of the latch spring 117.

However, in the hood latch according to the related art, since a rotation direction of the pole 118 and a rotation direction of the latch 114 are opposite to each other, rotation radiuses of the pole 118 and the latch 114 are increased at the time of opening or closing the hood. Therefore, a size of the hood latch including the support base 112 is increased, such that a layout configuration is limited.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a hood latch structure capable of minimizing a size.

In an aspect of the present invention, a hood latch structure may include a base plate mounted in a vehicle, a pole rotatably provided at the base plate, a hood release cable having one end connected to the pole to rotate the pole, and a latch having a first end rotatably mounted at the base plate and a latching groove formed at a center thereof to allow a hood striker to be selectively inserted thereinto, wherein the latching groove is selectively engaged with the pole.

A first elastic member is coupled to the pole and the base plate to rotatably bias the pole in a rotation direction.

The hood latch structure may further include a second elastic member having one end connected to the base plate and the other end connected to a second end of the latch to bias the latch in the rotation direction.

The pole is provided with a latching groove and the latch is provided with a latching protrusion, wherein the latching protrusion of the latch is selectively engaged with the latching groove of the pole according to rotation of the latch.

The pole is provided with a pole protrusion, wherein when the latch is rotated by the striker, the latching protrusion of the latch overcomes the pole protrusion and is locked to the latching groove of the pole.

The base plate is formed to may have a rectangular plate shape, and the pole and the latch are not protruded to the outside of the base plate at the time of being rotated.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view showing a hood latch according to the related art.

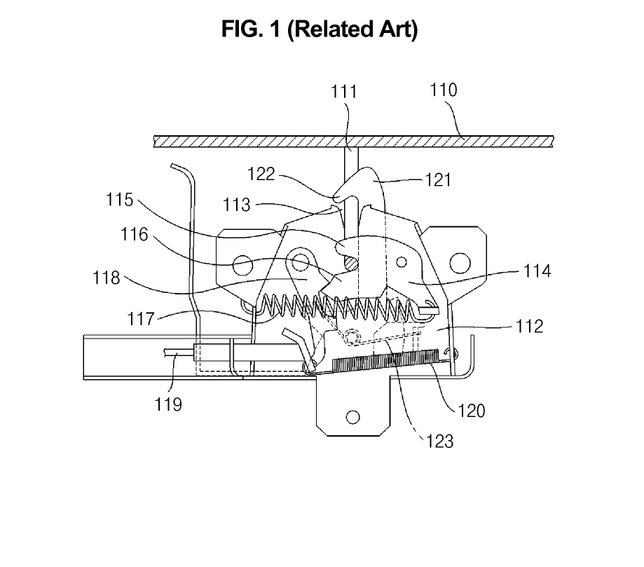

FIG. 2 is a view showing a state before and after a hood latch structure according to an exemplary embodiment of the present invention is operated.

FIG. 3 is a view showing a state in which a pole and a latch are engaged with each other in the hood latch structure according to the exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Exemplary embodiments of the present invention will be described in detail with reference to the accompanying drawings.

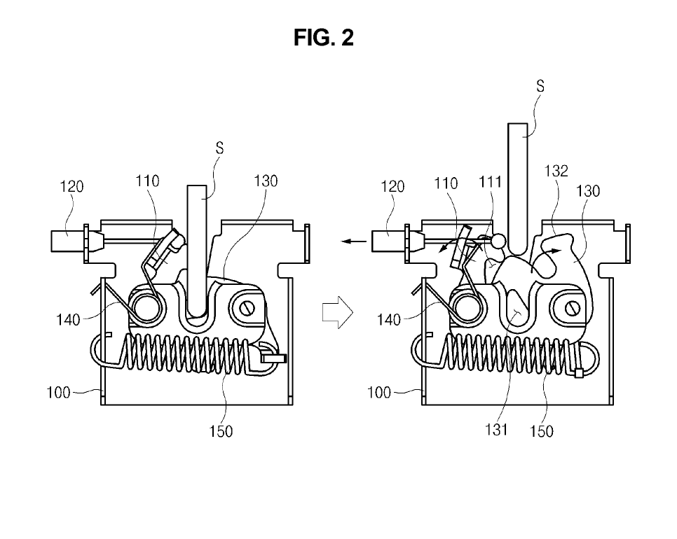

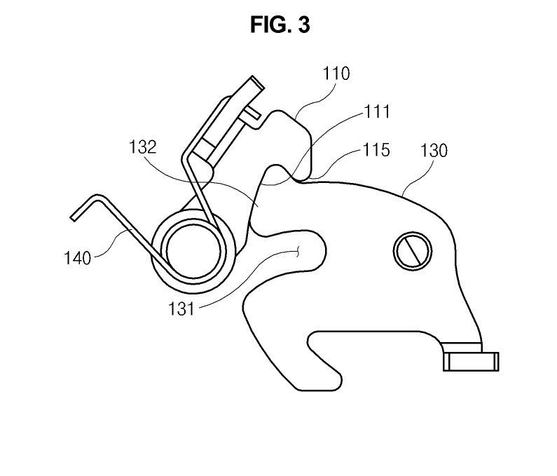

A hood latch structure according to an exemplary embodiment of the present invention is configured to include a base plate 100 mounted in a vehicle, a pole 110 provided at the base plate 100, a hood release cable 120 connected to the pole 110 to rotate the pole 110, and a latch 130 engaged with the pole 110 to rotate together with the pole 110 at the time of rotation of the pole 110, as shown in FIGS. 2 and 3.

As shown in FIG. 2, the base plate 100 is formed to have a rectangular plate shape and is mounted at an engine room side of the vehicle.

The pole 110 is rotatably provided at one end of the base plate 100.

Here, a latch 130 to be described below is rotatably provided at the other end of the base plate 100.

The hood release cable 120, which connects a handle and the pole 110 to each other, has one end connected to a hood opening handle provided in the vehicle and the other end connected to the pole 110.

As a result, when a passenger operates the handle in the vehicle, the hood release cable 120 connected to the handle is pulled, such that the pole 110 connected to the hood release cable 120 is rotated from the base plate 100.

Here, it is preferable that the pole 110 includes a first rotation spring 140 so as to be rotatable from the base plate 100 to allow the pole 110 to have restoring force after the pole 110 is rotated.

As shown in FIGS. 2 and 3, the latch 130 has one end rotatably mounted at the base plate 100 and the other end engaged with the pole 110. Therefore, when the pole 110 is rotated by the hood release cable 120, the latch 130 engaged with the pole 110 is also rotated.

Here, the latch 130 includes a latching groove 131 formed at the center thereof to allow a hood striker S formed at a hood to be inserted thereinto.

As a result, the hood striker S may be latched to or unlatched from the latch 130 according to whether or not the latch 130 is rotated.

In addition, the latch 130 further includes a second rotation spring 150. Here, it is preferable that one end of the second rotation spring 150 is connected to the base plate 100 and the other end thereof is connected to the latch 130 to allow the latch 130 to have restoring force after the latch 130 is rotated.

Meanwhile, it is preferable that the pole 110 is provided with a latching groove 111 and the latch 130 is provided with a latching protrusion 132, such that the pole 110 and the latch 130 may be selectively engaged with each other.

In an exemplary embodiment of the present invention, the pole 110 is provided with a pole protrusion 115, and thus when the latch 130 is rotated by the striker S, the latching protrusion 132 of the latch 130 overcomes the pole protrusion 115 and is locked to the latching groove 111 of the pole 110.

As described above, according to the exemplary embodiment of the present invention, when the handle in the vehicle is operated in order to open the hood, the hood release cable 120 pulls and rotates the pole 110. When the pole 110 is rotated, the latch 130 engaged with the pole 110 is rotated to unlatch the hood striker S latched to the latch 130 to enable opening of the hood. As described above, the base plate 100 is formed to have the rectangular plate shape, and the pole 110 and the latch 130 are formed at a minimized size and are not protruded to the outside of the base plate 100 even at the time of being rotated, thereby making it possible to minimize a size of the hood latch structure according to the exemplary embodiment of the present invention.

As set forth above, according to the exemplary embodiment of the present invention, a size of the hood latch structure is minimized to be advantageous for a layout, such that design performance is improved and a cost is decreased, thereby making it possible to increase marketability.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings.

The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A hood latch structure comprising:
a base plate mounted in a vehicle;
a pole rotatably provided at the base plate;
a hood release cable having one end connected to the pole to rotate the pole; and
a latch having a first end rotatably mounted at the base plate and a latching groove formed at a center thereof to allow a hood striker to be selectively inserted thereinto,
wherein the latching groove is selectively engaged with the pole.

2. The hood latch structure of claim 1, wherein a first elastic member is coupled to the pole and the base plate to rotatably bias the pole in a rotation direction.

3. The hood latch structure of claim 2, further including a second elastic member having one end connected to the base plate and the other end connected to a second end of the latch to bias the latch in the rotation direction.

4. The hood latch structure of claim 1, further including a second elastic member having one end connected to the base plate and the other end connected to a second end of the latch.

5. The hood latch structure of claim 1,
wherein the pole is provided with a latching groove and the latch is provided with a latching protrusion, and
wherein the latching protrusion of the latch is selectively engaged with the latching groove of the pole according to rotation of the latch.

6. The hood latch structure of claim 5,
wherein the pole is provided with a pole protrusion; and
wherein when the latch is rotated by the striker, the latching protrusion of the latch overcomes the pole protrusion and is locked to the latching groove of the pole.

7. The hood latch structure of claim 1, wherein the base plate is formed to have a rectangular plate shape, and the pole and the latch are not protruded to the outside of the base plate at the time of being rotated.
